(19) United States
(12) Patent Application Publication
(10) Pub. No.: US 2022/0258382 A1
(43) Pub. Date: Aug. 18, 2022

(54) SYSTEM AND METHOD FOR FORMING A CASTING MOULD IN A FLEXIBLE MANNER FOR PRODUCING A CASTING PATTERN

(71) Applicant: CUBES GMBH, Salzburg (AT)

(72) Inventors: Edwin MEINDL, Nikolsdorf (AT); Karl WAGNER, Salzburg (AT); Christian FALCH, Nassereith (AT)

(21) Appl. No.: 17/626,121

(22) PCT Filed: Jul. 16, 2020
(86) PCT No.: PCT/EP2020/070195

§ 371 Date: Jan. 10, 2022

(30) Foreign Application Priority Data
Jul. 17, 2019 (DE) 10 2019 119 431.8

(51) Int. Cl. B29C 33/30; B22C 7/02; B22C 9/12; B29C 33/38; B29C 33/72

(52) U.S. Cl. CPC B29C 33/302; B22C 7/02; B22C 9/12; B29K 2075/00; B29C 33/3842; B29C 33/72; B29C 33/308

(57) ABSTRACT

A system and method for flexibly forming a casting mold and for manufacturing a casting model or a molded body having a mounting platform, a plurality of shaping rods for forming the casting mold or the molded body and a conveying unit for conveying the shaping rods to the mounting platform, the conveying unit is configured to individually grip and to place the shaping rods on the mounting platform, such that a stack of the shaping rods is formable, and that a side of the stack is formable by the position of the shaping rods, to form a region of the casting mold and wherein the positions of the single shaping rods in the stack reproduce the shape of the molded body, wherein the shaping rods are gluable to each other, such that the stack forms the molded body.

### CROSS-REFERENCE TO RELATED APPLICATION(S)

This application is a national US phase of PCT/EP2020/070195 which claims the benefit of the filing date of the German Patent Application No. 102019119431.8 filed 17 Jul. 2019, the disclosure of which is hereby incorporated herein by reference.

### TECHNICAL FIELD

Embodiments of the present invention relate to a system and a method for flexibly forming a casting mold for manufacturing a casting model. Furthermore, embodiments of the present invention relate to a system for manufacturing a molded body.

### TECHNOLOGICAL BACKGROUND

In the product development of today, the requirements with respect to the prototype construction are to manufacture prototypes in a rapid and flexible manner. For this purpose, no fixed and uniquely produced casting molds are formed, but adaptable casting molds are used, such that they may be adapted for the manufacture of different prototypes.

DE 203 20 712 U1 describes an adaptable molding tool for the manufacture of arbitrarily shaped planar components, for example. The molding tool is adjustable to a surface contour which corresponds to a surface contour of the component, wherein the surface contour of the molding tool is formed by a matrix made of single segment stamps. The segment stamps may be individually controlled and vertically displaced. At a predetermined position, the segment stamps are fixed in their vertical position.

In systems for manufacturing prototypes, on the one hand, a simple system structure is desired, which may be rapidly adapted to differently shaped prototypes.

### SUMMARY OF THE INVENTION

There may be a need to provide a system for manufacturing prototypes with a simple system structure which may be rapidly adapted to differently shaped prototypes and casting models, respectively.

A system and a method for flexibly forming a casting mold and for manufacturing a casting model according to the independent claims are provided.

According to a first aspect of the present invention, a system for flexibly forming a casting mold and for manufacturing a casting model is described. The system comprises a mounting platform, a plurality of shaping rods for forming the casting mold, and a conveying unit for conveying the shaping rods to the mounting platform along a conveying direction. The conveying unit is configured to grip (individually or multiple in groups) and to place the shaping rods on the mounting platform, such that a stack of the shaping rods is formable, and that a side of the stack is formable by the position of the shaping rods, to form a region of the casting mold.

According to a further aspect, a method for flexibly forming a casting mold and for manufacturing a casting model is described. According to the method, at least one shaping rod is displaced to a mounting platform along a conveying direction, wherein the conveying unit is configured to grip and to place the shaping rods on the mounting platform, such that a stack of the shaping rods is formable, and that a side of the stack is formable by the position of the shaping rods, to form a region of the casting mold.

The casting model is a three-dimensional object, for example a tool-, mold-, or model block which is suitable for manufacturing a prototype. In particular, the casting model is a cast component which may be cast from plastic, for example, such as polyurethane (PUR), synthetic resin, or ureol, or from metallic materials, such as aluminum. For example, the casting model may have a length between 2000 mm (millimeter) and 4000 mm, in particular 3000 mm, may have a width of 1000 mm to 2000 mm, in particular 1500 mm, and may have a height of 1000 mm to 3000 mm, in particular 2000 mm.

After casting the casting model in the system according to embodiments of the invention, it may be further processed in further production facilities, such as an oven or a surface treatment unit (grinding machines etc.).

For example, the shaping rods may be made of a metallic material, such as steel or aluminum, or of a plastic, such as polyethylene (PE). The shaping rods comprise a stackable cross section, for example a rectangular cross section. Furthermore, the shaping rods respectively comprise two opposing front surfaces. For example, an end region of a shaping rod forms with its front surface and its surface a region of the casting mold. The shape of the casting mold is formed by the single shaping rods (in particular horizontally) protruding more or less in the casting mold. The regions of the shaping rods, which protrude from the stack in the region of the casting mold and are offset inwardly, form the corresponding negative molds of the casting model and the corresponding contours of the casting mold, respectively. The shaping rods may comprise identical geometric dimensions with respect to each other. Alternatively, groups of shaping rods may comprise a different length, a different cross section, or differently shaped front surfaces or rod surfaces, for example curved and planar front surfaces or rod surfaces.

For example, the shaping rods may comprise a dimension of B×H×L=50×50×1500 mm and may have a weight between 3 and 4 kg/piece. The shaping rods may be arranged in an ordered manner in rod magazines. For example, 5500 to 6000 shaping rods may be stored in a rod magazine.

For example, a stack may comprise 2500 to 3000 shaping rods, to form a side of the casting mold.

A side of the casting mold is formed by a stack of shaping rods. The single shaping rods of a stack protrude more or less with their front surfaces and end regions, respectively, into the casting mold and thereby form a desired mold region of the casting mold and correspondingly a mold region of the casting model.

The mounting platform forms a bearing surface which is defined on a bottom for a stack of the shaping rods. The mounting platform consists of a rigid underground, such as a metallic material, for example steel plates. On the mounting platform, the single shaping rods are placed by the conveying unit. Correspondingly, also the casting mold is formed on the mounting platform. The mounting platform may also be considered as a predetermined region of a bottom, so that the shaping rods may be directly stacked on the bottom, for example.

The conveying unit is configured to individually grip the shaping rods. For this purpose, as subsequently described in more detail, the conveying unit may grip, suck, or magnetically fix the shaping rods, and may vertically lift them and correspondingly horizontally convey them between a storage position (for example the below described rod magazine) and the mounting region on the mounting platform. The conveying unit conveys the shaping rods in particular along a conveying direction which is in particular horizontal.

In an exemplary embodiment, after placing, the shaping rods of a stack, for example manually or by an adjustment device, may be displaced in the stack to a desired shape by the conveying unit, to pre-give the desired position of the shaping rods in the stack and correspondingly the shape of the casting mold.

In a further exemplary embodiment, the conveying unit may be controlled, in particular by a control unit, such that each shaping rod may be placed at a defined and pregiven position in the stack and correspondingly on the mounting region. In other words, the conveying unit is configured to place the shaping rods in particular in a loose manner (i.e. without formfitting connection or glue connection between the shaping rods with respect to each other) at pregiven positions in the stack. The stack of shaping rods may be formed in this way by the conveying unit at first placing the shaping rods in a first level exactly relatively to each other, and subsequently forming a second level of shaping rods on the first level. Thus, the stack may be vertically built level by level, until finally an entire side of the stack and therefore correspondingly a region of the casting mold is formed by the shaping rods. Correspondingly, in a further exemplary embodiment, the stack may be formable from, in particular parallel, shaping rods which are placed side-by-side and on top of each other, whose position is individually adjustable along a rod direction of the shaping rods by the conveying unit. The regions of the shaping rods, e.g. the front surfaces and the surface regions of the shaping rods, which form the casting mold, are individually placeable along a rod direction of the rods by the conveying unit. In other words, the conveying unit may be configured e.g. as a portal unit or with a robot arm, to place the shaping rods on the mounting platform according to the pregiven space parameters (X-Y-Z parameters). The conveying unit comprises driven linear axes, for example, to correspondingly displace the rods with respect to each other, and to be able to adapt the rods to the contour of the assigned cast component. Thus, a stack is built level by level, to form the casting mold.

According to a further aspect of the present invention, a system for manufacturing a molded body is described. The system comprises a mounting platform, a plurality of shaping rods for forming the molded body, and a conveying unit for conveying the shaping rods to the mounting platform. The conveying unit is configured to grip and to place the shaping rods on the mounting platform, such that a stack of the shaping rods is formable, wherein the positions of the single shaping rods in the stack reproduce the shape of the molded body. The shaping rods are gluable with respect to each other, such that the stack forms the molded body. In other words, for example, also a stack may be formed which itself forms the molded body to be manufactured, alternatively to specifying a casting mold. For example, for this purpose, the shaping rods are undetachably connected with each other, for example by gluing. Similar as the casting model, the molded body is a three-dimensional object, for example a tool-, mold-, or model block. In particular, the molded body is a component which may be manufactured from plastic, for example, such as polyurethane (PUR), synthetic resin, or ureol, or from metallic materials, such as aluminum, corresponding to the composition of the material of the shaping rods.

By embodiments of the present invention, in a simple manner, a stack made of a plurality of shaping rods may be formed, wherein the stack forms a region of a casting mold or forms a molded body itself. In particular, this is achieved by exactly placing the shaping rods on top of each other in a stack. Since the shaping rods may be placed on top of each other and comprise a corresponding geometrical shape which enables a stacking, complex holding devices of the single shaping rods are unnecessary. Since the conveying unit according to embodiments of the invention assembles the shaping rods layer by layer and may disassemble them correspondingly, no complex control mechanisms are further necessary to displace even single rods in a stack. The exact position of the single shaping rods is pregiven in its placing on the stack and does not have to be adjusted later, for example until a casting of the casting model. Thus, a robust system for flexibly forming a casting mold or a molded body is provided which moreover may be rapidly adapted to different casting models to be cast and molded bodies to be manufactured, respectively.

According to a further exemplary embodiment, a surface of the shaping rods, in particular the front surface of at least one shaping rod, is configured in a planar, curved, or angled manner. Correspondingly, groups of shaping rods may comprise a differently shaped surface and/or front surface, for example curved, angled, and planar surfaces and front surfaces, respectively. Depending on the surface shape of the side to be cast of the casting mold, the conveying unit may avail itself from one of the groups of shaping rods and may correspondingly place a shaping rod with a desired shape of the front surface on the stack.

According to a further exemplary embodiment, the system comprises a rod magazine for storing the shaping rods, wherein the conveying unit is configured to individually convey the shaping rods between the rod magazine and the mounting platform. The rod magazine may form a bearing surface on the bottom for storing the shaping rods. On the rod magazine, the single shaping rods may be stored in a loose manner, which are intended for a later use for forming the casting mold and are correspondingly grippable by the conveying unit. The rod magazine may also form a shelf system, in which the shaping rods may be stored individually or in groups. The rod magazine and the mounting platform may be integrally formed and may form a common bottom plate, for example.

According to a further exemplary embodiment, the rod magazine is arranged along the conveying direction from the rod magazine to the mounting platform behind the mounting platform.

According to a further exemplary embodiment, the conveying unit comprises a gripping unit for gripping one shaping rod or a plurality of shaping rods. The gripping unit may comprise two clamping jaws, for example, which clamp a shaping rod for the conveyance and fixation. Alternatively, the shaping rod may comprise a receiving opening, for example, in which the gripping unit may grip and fix the shaping rod.

According to a further exemplary embodiment, the gripping unit is configured as vacuum gripping unit with at least one vacuum suction plate, such that, for a rod fixation, the vacuum gripping unit fixes one or more shaping rods to be conveyed at the same time exclusively at the (upper) surface of the shaping rod. By forming a vacuum (respectively underpressure) between the vacuum suction plate and the upper surface of the shaping rod, it is possible that no enclosing and gripping, respectively, of the shaping rod is necessary for the fixation and conveyance of the shaping rod. Thus, the shaping rods may be placed in a stack in an abutting manner in one level, so that a dense package of shaping rods may be manufactured. Thus, the leakage of a casting compound through a slit between two abutting shaping rods is reduced and prevented, respectively.

According to a further exemplary embodiment, the gripping unit is configured as a magnetic gripping unit, such that, for fixing the rod, the magnetic gripping unit fixes at least one shaping rod to be conveyed, in particular exclusively, at the surface of the shaping rod. The magnetic gripping unit is in particular configured with an electromagnet, so that it may optionally activate and deactivate a magnetic force. For example, the shaping rods to be conveyed may consist of a magnetic and/or magnetizable material, such as a ferromagnetic material (for example metal). Alternatively, the shaping rods may consist of plastic, wherein magnetic inserts, for example consisting of magnetic and/or magnetizable material, such as a ferromagnetic material (for example metal), are attached to and/or inserted in the shaping rod.

According to a further exemplary embodiment, the system comprises a guiding frame made of at least one guiding rail. The guiding frame is arranged above the mounting platform and spaced apart from it, wherein the conveying unit is displaceably coupled to the guiding rail. For example, the conveying unit may be displaced along the guiding rails by a chain drive or a belt drive. For example, the guiding frame may consist of a guiding rail which is arranged in parallel to the conveying direction, and of a further guiding rail which is arranged orthogonally to the conveying direction. Thus, the conveying unit may reach each position in a level of the stack and may correspondingly place or lift the shaping rods. In particular, the conveying unit may be operated by pneumatic, hydraulic, or electric drives. In particular, linear motors may be used, to exactly position the conveying unit.

According to a further exemplary embodiment, the conveying unit is configured stationary and comprises a robot arm, wherein the robot arm is configured to grip and to place the at least one shaping rod on the mounting platform for forming the stack. For example, the robot arm may comprise the above described types of gripping units, to fix the shaping rods. For example, the robot arm may be fixedly mounted at the bottom and may be moved in a pivotable and translationally extendable manner.

In a further exemplary embodiment, the conveying unit is correspondingly configured to rotate the shaping rod. Rotating denotes, that a shaping rod comprises an axis of rotation which is parallel to a normal of the horizontal plane and parallel to the vertical direction, respectively. In other words, the shaping rod may be rotated in the horizontal plane. Thus, there is the possibility, that besides the first and the second side of the casting mold, also further sides of the casting mold may be formed by the conveying unit. The conveying unit may thus remove a shaping rod from a rod magazine, convey it horizontally to a desired stack position, and adjust its orientation by rotation in the horizontal plane.

The conveying unit may be further configured to form a further side of the stack which is opposing to the above mentioned side of the stack. The conveying unit may remove at least one shaping rod from a common rod magazine and may convey it in the conveying direction above the casting mold, for example, and place it at the second side. Rotating the shaping rod is not necessary.

According to a further exemplary embodiment, the system comprises a further conveying unit and a further rod magazine. The further conveying unit is configured to grip and to place shaping rods on the mounting platform, such that a further stack of the shaping rods is formable, and that a side of the further stack is formable by the position of the shaping rods, to form a further region of the casting mold. By the use of multiple conveying units, multiple sides of the corresponding casting mold may be rapidly manufactured.

In a further exemplary embodiment, furthermore multiple conveying units may be used, for example four conveying units, so that four distanced stacks are formed, in whose center the casting mold may be formed. Each stack forms a different region of the casting mold. For example, a first pair of conveying units may transport the shaping rods along the conveying direction between corresponding rod magazines and side-forming stacks, and a second pair of conveying units may transport the shaping rods along a direction perpendicular to the conveying direction between corresponding rod magazines and side-forming stacks.

Thus, a desired shape of a casting mold and correspondingly of a casting model may be fully circumferentially provided. In addition, for example in the mounting platform, a rod holding device may be provided which, in particular vertically, holds a plurality of shaping rods and may adjust and fix each single shaping rod in a predetermined vertical position. The shaping rods are placed such that they substantially extend along the direction of gravity and vertically, respectively. Thus, also the mounting platform may form a desired contour and shape of a bottom region of the casting mold by the rod holding device, and may correspondingly form a desired shape of the bottom of the casting model.

According to a further exemplary embodiment, the system comprises a sealing wall which is attachable on the mounting platform, such that a further side of the casting mold, which is free from the shaping rods, is sealed. The sealing wall may be configured in a planar or curved manner, for example. Besides a separate sealing wall, it may alternatively be formed by shaping rods of a stack. For example, the outermost columns of shaping rods of a stack may be extended to the maximum in the direction of the casting mold to therefore generate a respective lateral sealing wall. A further separate sealing wall is therefore obsolete. Correspondingly, for example a lower row and/or an upper row of shaping rods of a stack may be extended to the maximum, to correspondingly form a bottom region or a lid of the casting mold.

According to a further exemplary embodiment, the system comprises a casting device which is configured to insert a molding compound into the casting mold. For example, the casting device may be placed above the open casting mold and may let flow the respective molding compound into the casting mold. The casting device may be coupled with a reservoir of the casting material. After the assembly of the casting mold, it is cast with liquid casting material, in particular polyethylene, which is manufactured on site by a mixing facility, for example, and is conveyed by the casting device.

According to a further exemplary embodiment, the mounting platform comprises transport terminals which are configured for coupling with a transport unit, such as a crane or a forklift, to convey the mounting platform, in particular with the stack. Thus, the mounting platform comprising the stack and the casting model may be conveyed, for example. Alternatively, at an assembly location, the mounting platform may be assembled with the respective stacks, for example, and may be subsequently conveyed by the transport unit to a casting location, where the casting device is provided, for example. After casting, the mounting platform may be further transported to an oven, to cure the casting model.

Correspondingly, a manufacturing system may be formed which comprises a plurality of above described systems with corresponding mounting platforms and conveying units, for example, in which the corresponding mounting platforms may be simultaneously assembled with stacks, wherein subsequently the corresponding mounting platforms may be supplied to the external casting device. In particular, since the assembly process of the stacks takes more time than casting, and therefore a manufacturing process is efficiently provided.

According to a further exemplary embodiment, the system comprises a pressing unit which is configured for pressing, e.g. along the gravity direction or laterally on the stack and laterally against the stack, to prevent a displacement of the rods. The pressing unit may be displaced together with the conveying unit, for example. For example, the pressing unit comprises a crossbeam which extends transversely to the conveying direction and may press onto the stack from above. On the one hand, the shaping rods maintain the stack due to their gravity. Additionally, due to the pressure of the pressing unit, the position of the shaping rods in the stack may be reinforced.

Furthermore, the system comprises a further pressing unit, which, along a horizontal direction, i.e. laterally, clamps at least one level of shaping rods of a stack in the horizontal direction. In particular, each completely laid level may be clamped.

Therein, the clamping of all previously laid levels is released for a short time and clamped again. In this way, a so-called repositioning, i.e. bracing, of the shaping rods by their own weight is enabled and the gaps due to rod tolerances are closed.

According to a further exemplary embodiment, the mounting platform comprises a mounting plate which is detachably mounted to the mounting platform, wherein the mounting platform forms a bottom of the casting mold. Therefore, the casting model may be formed and cured on the mounting plate. Subsequently, the casting model may be removed from the mounting platform together with the mounting plate and may be conveyed to the further processing.

According to a further exemplary embodiment, the mounting plate is removable from the mounting platform perpendicularly to the conveying direction. In particular, the mounting platform may comprise an opening with two lateral guiding rails, in which the mounting plate is insertable in a drawer-like manner.

According to a further exemplary embodiment, the conveying unit is configured to individually grip the shaping rods or to grip a group of shaping rods and to remove them from the stack and to convey them, in particular against the conveying direction. Therefore, after the curing of the casting mold, each shaping rod may be conveyed into the rod magazine again by the conveying unit and may be reused for a following casting mold.

According to a further exemplary embodiment, the conveying unit comprises a coupling element which engages in a receiving opening of a shaping rod, such that a demolding force (German: Entformungskraft) is transferable on the shaping rod, in particular against the conveying direction. In particular, the demolding force is antiparallel with respect to the conveying direction. After the curing of the casting material, the shaping rods may adhere at the casting model, so that a corresponding demolding force (for example 2000 N to 5000 N) is necessary, to detach a shaping rod from the casting model. By adhesion, shrinking, and other influences, the shaping rods adhere to the casting model. Shaping rods made of polyethylene may be properly demolded and removed, respectively, from the casting model. In particular, a tensile force against the conveying direction, i.e. along a deforming direction, of 200 kg to 400 or 600 kg tensile force may be applied.

In particular, the demolding force is introduced by the conveying unit, wherein in a preferred embodiment, respectively one single shaping rod is individually demolded, while other shaping rods bear at the casting model and therefore prevent an undesired force transmission to the system.

According to a further exemplary embodiment, the receiving opening comprises an internal thread, in particular a thread insert, and the coupling element is configured as a threaded pin. Therefore, a lifting force, i.e. a vertical force, may additionally be transferred between the conveying unit and the shaping rod, so that also a lifting of the shaping rod is possible.

According to a further exemplary embodiment, the coupling element is configured as a bolt for forming a form fit with the receiving opening, to transfer the demolding force.

The receiving opening correspondingly comprises an indentation direction in the shaping rod, which is configured perpendicularly to the conveying direction. Therefore, a bolt as coupling element may engage in the receiving opening and may form a form fit, so that a horizontal force (tensile force and demolding force, respectively) may be applied.

According to a further exemplary embodiment, the receiving opening is configured with an undercut, and the bolt is configured for coupling in the receiving opening, wherein in particular the bolt is configured as a ball lock bolt. The bolt and/or the material of the shaping rod in which the undercut is formed, are configured elastically, for example, so that, when pushing the bolt into the receiving opening, a coupling region of the bolt (for example a ball of the ball lock bolt) gets caught by the undercut, so that a stable connection between the bolt and the shaping rod is established.

According to a further exemplary embodiment, at least one of the shaping rods comprises the receiving opening at its surface, so that the coupling element is perpendicularly (in particular vertically) coupleable in the receiving opening.

According to a further exemplary embodiment, at least one of the shaping rods comprises a further front surface which is opposing the front surface, wherein the receiving opening is formed in the further front surface.

According to a further exemplary embodiment, the conveying unit comprises a further coupling element which is configured to engage in a receiving opening of a further shaping rod, such that a demolding force is transferable to a further shaping rod, in particular against the conveying direction. Correspondingly, the conveying unit may grip a plurality of shaping rods and may be coupled with a plurality of shaping rods, respectively, to simultaneously detach a plurality of shaping rods from the cast casting model and the stack in the demolding direction.

According to a further exemplary embodiment, the coupling element and the further coupling element are displaceable along the conveying direction independently from each other, to selectively apply a demolding force along a demolding direction (which is configured against the conveying direction) on the shaping rod or the further shaping rod. Therefore, for example a coupling with two or more shaping rods may be enabled, wherein only a part of the shaping rods is detached by a coupling element along the demolding direction. Due to the coupling of the other coupling elements with the shaping rods, a holding force is provided to the conveying unit at the remaining stack, so that a rod may be detached along the demolding direction, and the counter forces may be transferred from the conveying unit to the stack. Thereby, for example, the guiding frame at which the conveying unit is fixed, is discharged, since the force flow runs through the stack, and not through the guiding frame.

According to a further exemplary embodiment, the system further comprises a cleaning unit for cleaning at least the front surfaces of the shaping rods. The cleaning unit comprises a cleaning opening through which a rod to be cleaned is insertable along the conveying direction. After removing, the rods are thus conveyed by the conveying unit to the cleaning device without intermediate storage, and are cleaned by inserting and removing the shaping rods in the cleaning device. Subsequently, the shaping rods are placed at the rod magazine.

For example, the cleaning unit is fixed above the mounting platform, for example at the guiding frame. In particular, the cleaning unit may be arranged above or besides the mounting platform, so that the conveying of the shaping rods to the casting mold is not impeded. The cleaning unit comprises cleaning elements which mechanically detach cured molding compound, for example. Correspondingly, the cleaning elements may comprise rough surfaces, to grind the cured molding compound. Furthermore, the cleaning elements may comprise the spatula elements which are described below, to scratch off the cured molding compound from a shaping rod. Moreover, the cleaning unit may comprise a spraying unit for applying a chemical cleaning agent, for example.

The cleaning unit comprises at least one opening which is configured such that a shaping rod may be retracted and extended in parallel to the conveying direction. Thus, after removing a shaping rod from the stack, the conveying unit at first may insert the shaping rod in the cleaning unit and may subsequently place the cleaned shaping rod in the rod magazine. Thus, the cleaning process of the shaping rods may be integrated in the system and may enable a reusability of the shaping rods without further treatment stages.

According to a further exemplary embodiment, the cleaning unit comprises a spatula element, which is configured such that, when displacing and/or moving the shaping rod into the cleaning unit, the spatula element scratches along a surface and the front surface of the shaping rod. Thus, cured molding compound of the material may be scratched off and the shaping rod may be cleaned in this way. The spatula elements may be elastically biased, for example by spring elements, wherein by retracting a shaping rod, the spatula elements scratch along the front surfaces and the surface of the shaping rod and at the same time push the spatula elements away. Therefore, an extensive cleaning of the shaping rods may be guaranteed.

According to a further exemplary embodiment, the system comprises a control unit for controlling the conveying unit. The control unit is configured to determine the position data of the single shaping rods for forming the casting mold based on model data of the casting model to be manufactured.

In particular, control unit denotes a unit with a processor resource which is configured for—in particular program technically—processing the provided data of the casting mold and the casting model, respectively, and which is further configured for controlling the conveying unit. During the processing, the processor resource may be communicatively coupled with a data storage resource of the control unit in a unidirectional or preferably bidirectional manner, to read data from there and/or to store data in it. For example, the control unit may be configured as a computer and processor, respectively, or as plurality of cooperating computers or processors (which may be spatially close to each other or spatially separated from each other). For example, the control unit may be connected with a casting model-database by wire or wirelessly, for example via the internet, to exchange corresponding data. In particular, the casting model-data may be obtained from a CAD-tool.

The control unit is configured to generate machine-readable instructions based on the casting mold model, to thereby control the conveying unit.

It is noted, that the here described embodiments merely constitute a limited selection of possible embodiment variants of the invention. It is possible to combine the features of single embodiments in a suitable manner, so that by the here explicit embodiment variants, a plurality of different embodiments are to be considered as obviously disclosed for a person skilled in the art. In particular, some embodiments of the invention are described with device claims and other embodiments of the invention are described as method claims. For a person skilled in the art, when reading this application, it is nevertheless immediately clear that, unless explicitly otherwise specified, additionally to a combination of features which belong to one type of subject matter of the invention, also an arbitrary combination of features is possible, which belong to different types of subject matters of the invention.

### DETAILED DESCRIPTION OF EXEMPLARY EMBODIMENTS

In the following, for a further explanation and for a better understanding of embodiments of the present invention, embodiments are described in more detail with reference to the accompanied drawings. It is shown by:

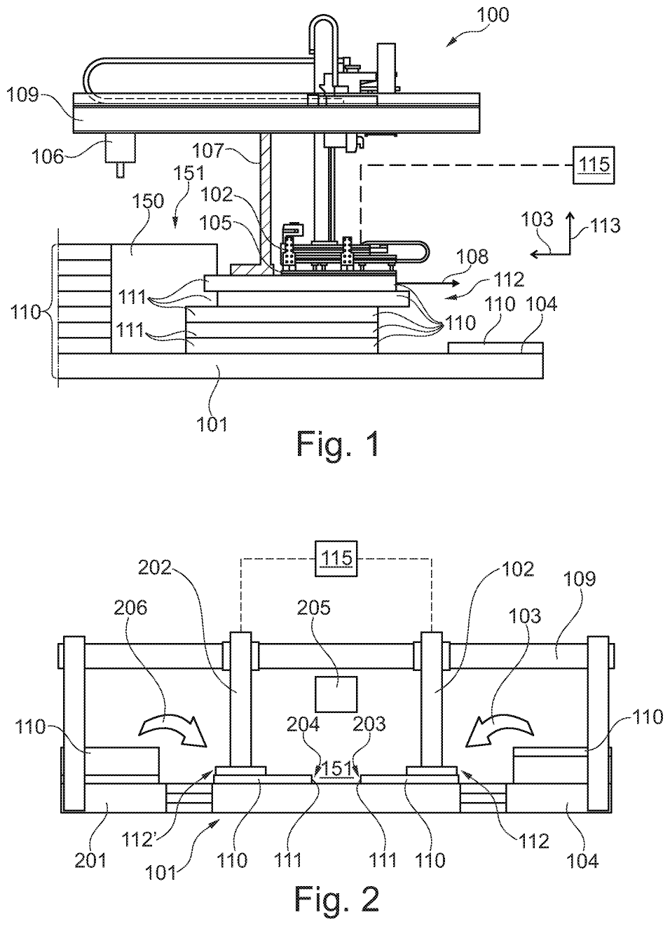

FIG. 1 a schematic illustration of a side view of the system according to an exemplary embodiment of the present invention.

FIG. 2 a schematic illustration of a side view of the system comprising two conveying units according to an exemplary embodiment of the present invention.

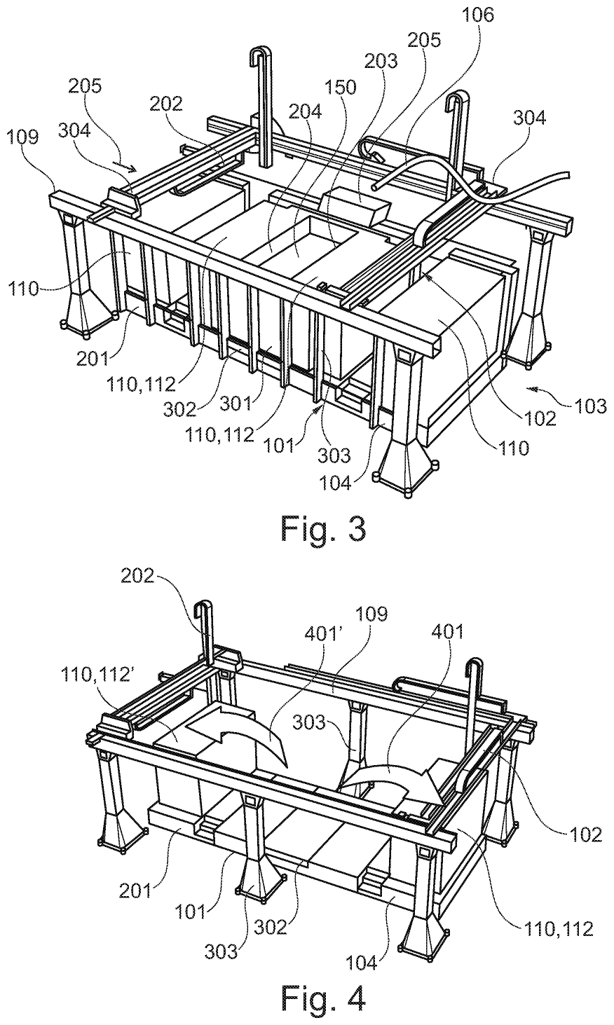

FIG. 3 a perspective illustration of a system comprising two conveying units, wherein a casting mold is formed by shaping rods, according to an exemplary embodiment of the present invention.

FIG. 4 a perspective illustration of a system comprising two conveying units, wherein the shaping rods are stored on rod magazines, according to an exemplary embodiment of the present invention.

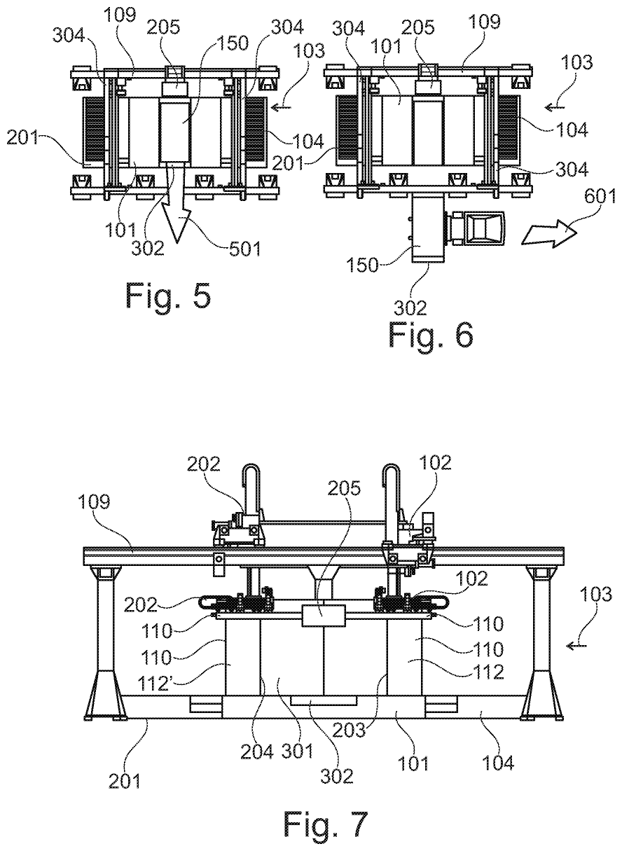

FIGS. 5 and 6 plan views of a system, in which a discharging process of a model is illustrated, according to an exemplary embodiment of the present invention.

FIG. 7 a side view of a system, wherein a shaping rod is present in a cleaning unit, according to an exemplary embodiment of the present invention.

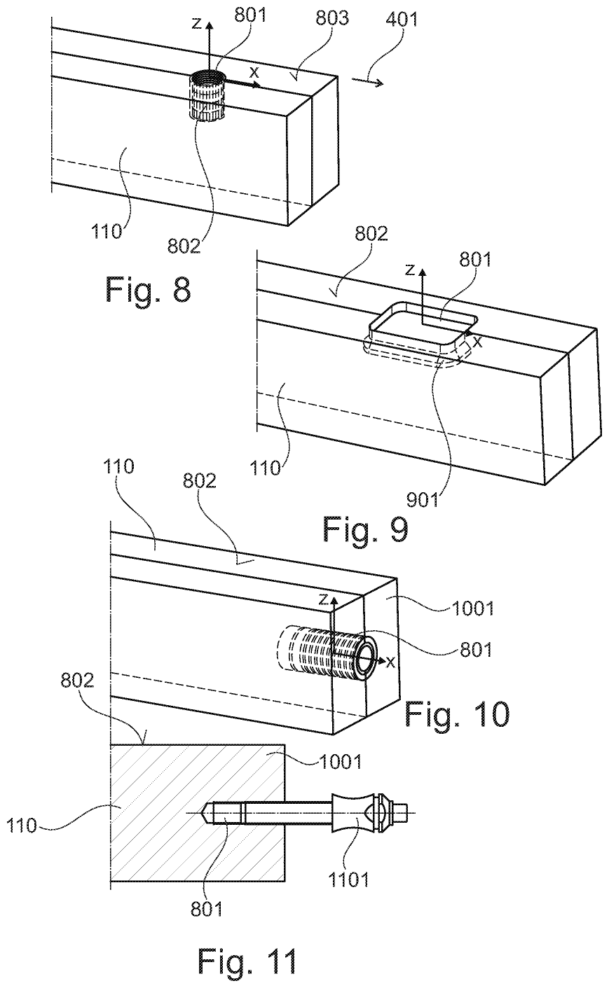

FIG. 8 to 12 perspective illustrations of shaping rods with receiving openings for a coupling element, according to exemplary embodiments of the present invention.

FIG. 13 a perspective illustration of a conveying unit according to an exemplary embodiment of the present invention.

FIG. 14 a side view of a conveying unit, as illustrated in FIG. 13.

Same or similar components in different figures are provided with the same reference numbers. The illustrations in the figures are schematic.

FIG. 1 shows a side view of a system 100 for flexibly forming a casting mold 151 and for manufacturing a casting model according to an exemplary embodiment of the present invention. The system 100 comprises a mounting platform 101, a plurality of shaping rods 110 for forming the casting mold 151, and a conveying unit 102 for conveying the shaping rods 110 to the mounting platform 101 along a conveying direction 103. The conveying unit 102 is configured to individually grip the shaping rods 110 or to grip multiple shaping rods 110 in groups and to place them, in particular in a loose manner, at pregiven positions of the mounting platform 101, such that a stack 112 of the shaping rods 110 is formable, and that a side 203 of the stack 112 is formable by the position of the shaping rods 110, to form a region of the casting mold.

The shaping rods 110 comprise a stackable cross section, for example a rectangular cross-section. Furthermore, the shaping rods 110 respectively comprise two opposing front surfaces 111, 1001 (see FIG. 10). The region of a shaping rod 110, which is protruding in the casting region, which comprises e.g. an end region with a front surface 111, forms a region of the casting mold 151. The shape of the casting mold 151 is formed by the single shaping rods 110 protruding more or less in the casting mold (in particular horizontally along the conveying direction 103). The shaping rods 110 may comprise identical geometric dimensions with respect to each other.

At least one region of the casting mold 151 is formed by a stack 112 of shaping rods 110. The single shaping rods 110 of a stack 112 protrude more or less with their end regions comprising the front surfaces 111 in the casting mold 151, and therefore form a desired lateral region of the casting mold 151 and correspondingly a lateral region of the casting model 150.

The mounting platform 101 forms a bearing surface which is defined on a bottom for a stack 112 of the shaping rods 110. The mounting platform 101 consists of a solid underground, such as steel plates. On the mounting platform 110, by the conveying unit 102, the single shaping rods 110 are placed. Correspondingly, on the mounting platform 101, also the casting mold 151 is formed.

The conveying unit 102 is configured to individually grip the shaping rods 110. For this purpose, the conveying unit 110 may grip or suck the shaping rods 110 and may vertically lift and convey them correspondingly horizontally between a storage position (for example a rod magazine 104) and the mounting region on the mounting platform 101, as subsequently described in more detail. The conveying unit 102 conveys the shaping rods 110 in particular along the conveying direction 103 which is in particular horizontal. In particular, the conveying unit 102 may be controlled by a control unit 150, such that each shaping rod 110 may be placed at a defined position on the mounting region. The stack 112 of the shaping rods 110 may be formed by the conveying unit 102 at first placing the shaping rods 110 in a first (horizontal) level exactly relatively with respect to each other, and subsequently forming a second level of shaping rods 110 on the first level. Therefore, the stack 112 may be vertically built level by level, until finally an entire region of the casting mold 151 is formed by the shaping rods 110 of the stack 112. Correspondingly, the stack 112 may be formed by, in particular parallel, shaping rods 110 which are placed next to each other and above each other, whose front surfaces 111 which form the casting mold 151, are individually placeable along a rod direction of the rods 110 by the conveying unit 102.

Furthermore, the system 100 comprises a rod magazine 104 for storing the shaping rods 110 outside of the mounting region, wherein the conveying unit 102 is configured to individually convey the shaping rods 110 between the rod magazine 104 and the mounting platform 101. The rod magazine 104 may form a bearing surface on the bottom for storing the shaping rods 110. On the rod magazine 104, the single shaping rods 110 may be stored in a loose manner, which are intended for a later use for forming the casting mold 151 and are correspondingly grippable by the conveying unit 102. The rod magazine 104 and the mounting platform 101 may be integrally formed and may form a common bottom plate, for example.

In the shown embodiment, the rod magazine 104 is arranged along the conveying direction 103 behind the mounting platform 101.

In the shown exemplary embodiment, the gripping unit of the conveying unit 102 is configured as a vacuum gripping unit with at least one vacuum suction plate 105, such that, for a rod fixation, the vacuum gripping unit fixes a shaping rod 110 to be conveyed exclusively at its (upper) surface 803 (see FIG. 8). By forming a vacuum (respectively underpressure) between the vacuum suction plate 105 and the upper surface 803 of the shaping rod 110, it is possible that no enclosing and/or gripping of the shaping rod 110 is necessary for the fixation and the conveyance of the shaping rod 110. Therefore, the shaping rods 110 may be placed in a stack 105 abuttingly on each other in a level, such that a dense package of shaping rods 110 may be manufactured.

The system 100 comprises a guiding frame 109 consisting of at least one guiding rail 109. The guiding frame 109 is arranged above and spaced apart from the mounting platform 101, wherein the conveying unit 102 is displaceably coupled to the guiding rail. The conveying unit 101 may be displaced along the guiding rails, for example by a chain- or belt drive.

The system 100 further comprises a casting device 106 which is adapted to introduce a molding compound into the casting mold 151. For example, the casting device 106 may be placed above the open casting mold 151 and may let flow the respective casting material into the casting mold 151.

Furthermore, the system 100 comprises a pressing unit 107 which is adapted to press on the stack 112 along the gravity direction, to prevent a displacement of the shaping rods 110. The pressing unit 107 may be displaced together with the conveying unit 102, for example. For example, the pressing unit 107 comprises a crossbeam which extends transversely to the conveying direction 103 and may push on the stack 112 from above. On the one hand, the shaping rods 110 maintain the stack 112 due to their force of gravity. Additionally, due to the pressure of the pressing unit 107, the position of the shaping rods 110 in the stack 112 may be reinforced. Furthermore, a further pressing unit may be provided, which clamps at least one level of shaping rods 110 of a stack 112 along a horizontal direction, i.e. laterally, in the horizontal direction. Therefore, in particular each completely laid level may be clamped.

Furthermore, the conveying unit 102 is configured to individually grip the shaping rods 110 and to remove them from the stack 112 and to convey them, in particular against the conveying direction 103. Thus, after curing the casting mold 151, each shaping rod 110 may be conveyed in the rod magazine 104 again by the conveying unit 102, and may be reused for a subsequent casting mold.

The conveying unit 102 may comprise a coupling element (for example a bolt or a pin) which engages in a receiving opening 801 (see FIG. 8) of a shaping rod 110, such that a demolding force 108, for example of 5000 Newton, is transferable to the shaping rod 110 against the conveying direction 103. In particular, the demolding force 108 is antiparallel to the conveying direction 103. After curing the casting material, the shaping rods 110 may adhere at the casting model 150, such that a respective demolding force 108 is necessary, to release a shaping rod 110 from the casting model 150. Examples for respective receiving openings 801 and coupling elements are illustrated in the embodiments of FIG. 8 to FIG. 12.

A control unit 115 is configured for controlling the conveying unit 102. The control unit is configured to determine the position data of the single shaping rods 110 for forming the casting mold 151, based on model data of the casting model 150 to be manufactured. The control unit 115 is configured to generate machine-readable instructions based on the casting mold model 150, to thereby control the conveying unit 102.

FIG. 2 shows a schematic illustration of a side view of a system comprising two conveying units 102, 202 according to an exemplary embodiment of the present invention.

The system 100 may further comprise a further conveying unit 202 and a further rod magazine 201. The further conveying unit 202 is configured to form a second side 204 of a further stack 112, which differs from a first side 203 of the stack 112 by the single shaping rods 110 being displaceable along a further conveying direction 206, wherein the further rod magazine 201 is arranged along the further conveying direction 206 behind the mounting platform 101. Therefore, two opposing stacks 112, 112′ are assembled with shaping rods 110 by respectively one conveying unit 102, 202. By using multiple conveying units 102, 202, multiple sides 203, 204 of the respective stacks 112 may be rapidly manufactured for forming a respective casting mold 151.

The system 100 further comprises a cleaning unit 205 for cleaning at least the front surfaces 111 of the shaping rods 110. The cleaning unit 205 is described in the embodiment of FIG. 7.

At the beginning of the process, at first the job data are loaded in the control unit 115, for example via the Internet, and corresponding space coordinates of the single shaping rods 110 on the mounting platform 101 are determined. Subsequently, the conveying units 102 stack the shaping rods 110 corresponding to the space coordinates. The conveying unit 102 and the further conveying unit 202 may build up two opposing stacks 112, 112′ at the same time. Each completely laid level of a stack 112 may be subsequently clamped by the pressing unit 107 in a vertical direction from above, or laterally from a horizontal direction. After finishing a laid level of a stack 112, 112′, the clamping of all previously laid levels is released for a short time and is clamped again. In this way, a so-called repositioning (German: Nachsitzen) by the own weight of the shaping rods 110 is enabled and gaps due to rod tolerances are closed. Subsequently, the casting mold 151 may be filled by the casting device 106 with casting material, for example polyurethane, so that the material may cure (FIG. 3).

FIG. 3 shows a perspective illustration of a system 100 comprising two conveying units 102, 202, wherein a casting mold 150 with shaping rods 110. The guiding frame 109 may consist of two opposing guiding rails, for example, which are parallel to the conveying direction 104, and further guiding rails (respectively bridges 304) which are orthogonal to the conveying direction 103 and connect the both opposing guiding rails. Therefore, the conveying unit 102, 202 may reach each position of a level of the stack 112 and may correspondingly place or lift the shaping rods 110. In particular, the conveying units 102, 202 may be linear motors and may be exactly positioned, in order to position.

In the present embodiment, two opposing sides 203, 204 of opposing stacks 112, 112′ are formed with a respective stacking of the shaping rods 110. The sidewalls which connect the first side 203 and the second side 204 are closed with sealing walls 301, so that a closed casting mold 151 is generated. At the upper region, the casting mold 151 may comprise an opening between the both stacks 112, through which the casting device 106 may introduce the casting material. For example, the outermost columns of the shaping rods 110 of a stack may be extended in the direction of the casting mold 151 to a maximum extent, to therefore generate a respective lateral sealing wall 301. Correspondingly, for example a lower row and/or an upper row of shaping rods 110 of a stack 112 may be extended to the maximum extent, to correspondingly form a bottom region or a lid of the casting mold 151. The sealing walls 301 may be additionally supported by reinforcing beams 303, to form a stable casting mold 151. The reinforcing beams 303 may further push laterally against the stack 112, to clamp the respective stack 112 as a clamping device. For example, the reinforcing beams 303 may be laterally displaced by a drive unit, and may thus be released from the sealing wall or the stack 112. The reinforcing beams 303 which temporarily cover the mounting plate 302, may be removed, for example, in order to be able to temporarily remove the mounting plate 302. The sealing wall 301 may be configured in a planar or curved manner, for example.

The mounting platform 101 further comprises a mounting plate 302, on which the casting model 150 may be formed. The mounting plate 302 may be exchangeably attached to the mounting platform 101.

FIG. 4 shows a perspective illustration of a system 100 comprising two conveying units 102, 202, wherein the shaping rods 110 are stored on rod magazines 104, 201. After casting a casting model 150, the single shaping rods 110 may be stored on the respective rod magazines 104, 201 along the demolding direction, so that a new casting mold 151 may be subsequently formed. By adhesion, shrinking, and other influences, the shaping rods 110 adhere to the casting model 150. In particular, a tensile force against the conveying direction, i.e. along a demolding direction 401, of 200 kg to 400 or 600 kg tensile force may be applied. The actual formation is performed by the conveying unit 102, 202. The other shaping rods 110 of the stack 112 remain adhered at the casting model 150 for stabilization.

FIG. 5 and FIG. 6 show plan views of a system 100, in which a discharging process of a casting model 150 is illustrated. The mounting platform 101 comprises the mounting plate 302 which is detachably fixed to the mounting platform 101. The mounting plate 302 forms a bottom of the casting mold 151. The casting model 150 may therefore be formed and cured on the mounting plate 302. Subsequently, the casting model 150 may be removed from the mounting platform 101 together with the mounting plate 302, and may be conveyed to a further manufacturing unit 601.

The mounting plate 302 is removable from the mounting platform 101 perpendicularly to the conveying direction 103. In particular, the mounting platform 101 may comprise an opening with two lateral guiding rails, in which the mounting plate 302 may be inserted and removed in a drawer-like manner along the moving direction 501. The mounting plate 302 may comprise rollers, for example, by which it is displaceable over the bottom. Subsequently, the mounting plate 102 may be picked up by an auxiliary unit, for example a forklift, and may be conveyed to a further manufacturing unit, for example an oven. A further empty mounting plate may be subsequently inserted in the mounting platform 101, so that a further casting mold 151 may be formed.

FIG. 7 shows a side view of a system 100, in which a shaping rod 110 of a cleaning unit 205 is present. For example, the cleaning unit 205 is fixed above the mounting platform 101, for example at the guiding frame 109. In particular, the cleaning unit 205 may be arranged above and next to the mounting platform 101, so that conveying the shaping rods 110 to the casting mold 151 is not impeded. The cleaning unit 205 comprises cleaning elements which mechanically release cured molding compound on the shaping rods 110, for example. The cleaning unit 205 comprises at least one opening which is configured such that a shaping rod 110 may be retracted and extended in parallel to the conveying direction 103 by the conveying units 102, 202. Therefore, after removing a shaping rod 110 from the stack 112, the conveying unit 102, 202 may at first insert the shaping rod 110 in the cleaning unit 205, and may subsequently place the cleaned shaping rod 110 in the rod magazine 104, 201.

In particular, the cleaning unit comprises two opposing openings along the conveying direction 103, wherein through each opening a shaping rod 110 to be cleaned may be individually inserted. For example, a first shaping rod 110 may be inserted by the conveying unit 102 through a first opening into the cleaning unit 205, and a second shaping rod 110 may be inserted by the further conveying unit 202 through a second opening into the cleaning unit 205. Thus, a simultaneous cleaning of two shaping rods 110 is possible, for example.

Furthermore, two cleaning devices 205 may be attached to a front side and a backside of the mounting platform 101, to enable a more rapid demolding of a stack 112.

FIG. 8 to FIG. 12 show perspective illustrations of shaping rods 110 with receiving openings 801 for coupling elements.

FIG. 8 shows an exemplary embodiment of a rectangular shaping rod 110 which comprises on its upper surface 803 an internal thread, which is formed by a thread insert 802, for example. The coupling element is configured as a threaded pin, for example, and may be controlled by the conveying unit 102. For example, the conveying unit 102 may be exactly place the threaded pin above the receiving opening 801 and may subsequently initiate a rotation of the threaded pin, to thereby enable a screwing in and screwing out in the thread insert 802. Therefore, besides the demolding force along the demolding direction 401, a lifting force, i.e. a vertical force, may be transferred between the conveying unit 102 and the shaping rod 110, so that a lifting of the shaping rod 110 is additionally possible.

FIG. 9 shows an exemplary embodiment of a rectangular shaping rod 110 which comprises on its upper surface 803 a receiving opening 801 for the coupling element. The receiving opening 801 is configured to form a form fit coupling with a bolt as coupling element. The receiving opening 801 correspondingly comprises an indentation direction in the shaping rod 110 which is formed perpendicularly to the conveying direction 103 and the demolding direction 401, respectively.

Thus, a bolt as coupling element may engage in the receiving opening 801 and may form a form fit, so that a horizontal force (tensile force and demolding force, respectively) along the demolding direction 401 may be applied.

The receiving opening 801 comprises a rectangular cross section and forms a rectangular pocket with an undercut 901, and the bolt is configured for coupling in the receiving opening 801. The bolt forms a snapping counterpiece and may be formed as a ball lock bolt 1101 (see FIG. 11). The bolt and/or the material of the shaping rod 110, in which the undercut 901 is formed, are formed elastically, for example, so that, when pushing the bolt in the receiving opening 81, a coupling region of the bolt (for example a ball of the ball lock bolt) engages with the undercut 901, so that a stable connection between the bolt and the shaping rod 110 is established.

FIG. 10 shows a further exemplary embodiment of a shaping rod 110, wherein the shaping rod 110 comprises a further front surface 1001 which is opposing the front surface 111, wherein in the further front surface 1001, the receiving opening 801 is formed. In FIG. 10, similar as in FIG. 8, an internal thread in the receiving opening 801 is provided.

FIG. 11 shows a further exemplary embodiment of a shaping rod 110, wherein the shaping rod 110 comprises a further front surface 1001 which is opposing the front surface 111, wherein in the further front surface 1001, the receiving opening 801 is formed. In FIG. 10, similar as in FIG. 9, a ball lock bolt for a reception in the receiving opening 801 is provided.

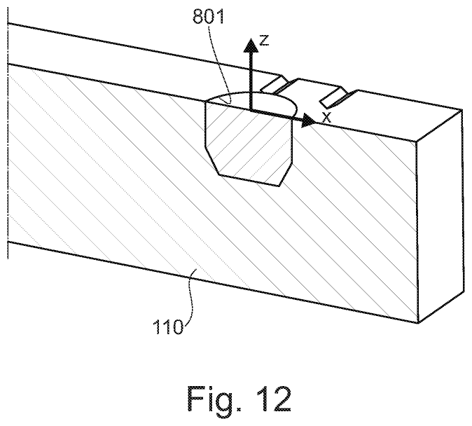

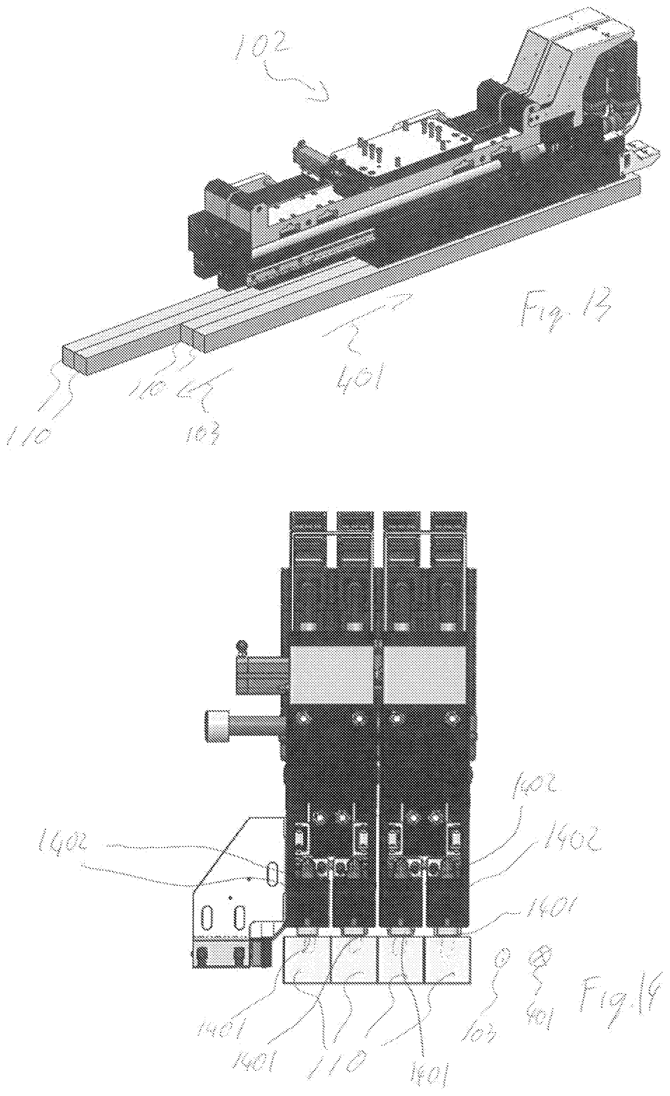

FIG. 12 shows an exemplary embodiment of a rectangular shaping rod 110 which comprises on its upper surface 803 a receiving opening 801 for the coupling element. The receiving opening 801 is formed as a round pocket which comprises a conical end section, so that a proper coupling with a bolt of the conveying unit is possible.

FIG. 13 and FIG. 14 show a perspective illustration of a conveying unit 102 according to an exemplary embodiment of the present invention.

For example, the conveying unit 102 comprises a plurality of sleds 1402 which are arranged side by side transversely to the conveying direction 103, which are arranged displaceably along the conveying direction 103. For example, each sled 1402 comprises a coupling element 1401, such as the bolt 1101 which is illustrated in FIG. 11. A sled or multiple sleds 1402 may be displaced selectively from each other along a demolding direction 401, to exert a demolding force on the correspondingly coupled shaping rods 110. The not displaced sleds 1402 which are nevertheless coupled to the shaping rods 110, transfer a corresponding counterforce to the demolding force via their coupling elements to the stack 112, so that the force flow due to the demolding of the shaping rods 110 may be dissipated via the stack 112 of the shaping rods 110 which are adhering to the casting model 150. Thereby, for example the guiding frame 109 to which is the conveying unit 102 is fixed, is relieved, since the force flow runs through the stack 112 and not through the guiding frame 109. Furthermore, the conveying unit 102 may comprise a bearing surface, by which the conveying unit 102 abuts on the shaping rods 110 which shall not be removed. Thus, the weight force of the conveying unit 102 may be directly introduced in the stack 112, and the guiding frame 109 may be relieved.

Supplementary, it is noted that “encompassing” does not exclude other elements or steps, and “a” or “an” does not exclude a plurality. Furthermore, it is noted, that features or steps which are described with reference to one of the above embodiments, may also be used in combination with other features or steps of other above described embodiments. Reference signs in the claims are not to be construed as limitation.

### LIST OF REFERENCE SIGNS

| | |
|---|---|
| 100 | system |
| 101 | mounting platform |
| 102 | conveying unit |
| 103 | conveying direction |
| 104 | rod magazine |
| 105 | vacuum suction plate |
| 106 | casting device |
| 107 | pressing unit |
| 108 | demolding force |
| 109 | guiding frame |
| 110 | shaping rod |
| 111 | front surface |
| 112 | stack |
| 113 | vertical direction |
| 115 | control unit |
| 150 | casting model |
| 151 | casting mold |
| 201 | further rod magazine |
| 202 | further conveying unit |
| 203 | first side of a stack |
| 204 | second side of a further stack |
| 205 | cleaning unit |
| 206 | further conveying direction |
| 301 | sealing wall |
| 302 | mounting plate |
| 303 | reinforcing beam |
| 304 | bridge |
| 401 | demolding direction |
| 501 | removing direction |
| 601 | further manufacturing unit |
| 801 | receiving opening |
| 802 | thread insert |
| 803 | upper surface |
| 901 | undercut |
| 1001 | further front surface |
| 1101 | bolt |
| 1401 | coupling element |
| 1402 | sled |

1.-31. (canceled)

32. System for flexibly forming a casting mold and for manufacturing a casting model, the system comprising:
a mounting platform,
a plurality of shaping rods for forming the casting mold, and
a conveying unit for conveying the shaping rods to the mounting platform,
wherein the conveying unit is configured to grip and to place the shaping rods on the mounting platform, such that a stack of the shaping rods is formable, and that a side of the stack is formable by the position of the shaping rods, to form a region of the casting mold.

33. System according to claim 32, comprising at least one of the following features:
wherein the conveying unit is configured to place the shaping rods at pregiven positions in the stack, in particular in a loose manner;
wherein the stack is formable of, in particular parallel, shaping rods which are placed next to each other and on top of each other, whose position, in particular along a rod direction of the shaping rods, is individually adjustable for each shaping rod by the conveying unit; and
wherein a surface of the shaping rods, in particular a front surface, of at least one shaping rod is configured planar, curved, or angled.

34. System according to claim 32, further comprising:
a rod magazine for storing the shaping rods,
wherein the conveying unit is configured to convey the shaping rods between the rod magazine and the mounting platform;
in particular wherein the rod magazine is arranged along a conveying direction from the rod magazine to the mounting platform behind the mounting platform.

35. System according to claim 32,
wherein the conveying unit comprises a gripping unit for gripping a shaping rod or a plurality of shaping rods.

36. System according to claim 35,
wherein the gripping unit is configured as a vacuum gripping unit with at least one vacuum suction plate, such that, for fixing a rod, the vacuum gripping unit fixes at least one shaping rod to be conveyed, in particular exclusively, at the surface of the shaping rod.

37. System according to claim 35,
wherein the gripping unit is configured as a magnetic gripping unit, such that, for fixing a rod, the magnetic gripping unit fixes at least one shaping rod to be conveyed, in particular exclusively, at the surface of the shaping rod in a magnetic manner.

38. System according to claim 32, further comprising at least one of the following features:
a guiding frame comprising at least one guiding rail,
wherein the guiding frame is arranged above the mounting platform and spaced apart from it,
wherein the conveying unit is displaceably coupled to the guiding rail;
wherein the conveying unit is configured stationary and comprises a robot arm, and
wherein the robot arm is configured to grip and to place the at least one shaping rod on the mounting platform for forming the stack.

39. System according to claim 32, further comprising:
a further conveying unit, and
a further rod magazine,
wherein the further conveying unit is configured to grip and to place shaping rods on the mounting platform, such that a further stack of the shaping rods is formable and that a side of the further stack is formable by the position of the shaping rods, to form a further region of the casting mold.

40. System according to claim 32, further comprising at least one of the following features:
a sealing wall which is attachable on the mounting platform, such that a further side of the casting mold, which is free from the shaping rods, is sealed;
a casting device which is configured to insert a molding compound into the casting mold;
wherein the mounting platform comprises transport terminals which are configured for coupling with a transport unit, to convey the mounting platform, in particular with the stack; and
a pressing unit which is configured to press onto the stack and laterally against the stack, to prevent a displacement of the rods.

41. System according to claim 32,
wherein the mounting platform comprises a mounting plate which is detachably mounted at the mounting platform,
wherein the mounting plate forms a bottom of the casting mold;
in particular wherein the mounting plate is removable from the mounting platform perpendicularly to the conveying direction.

42. System according to claim 32,
wherein the conveying unit is configured to individually grip the shaping rods or to grip a group of shaping rods and to remove them from the stack and to convey them, in particular against the conveying direction.

43. System according to claim 32,
wherein the conveying unit comprises a coupling element which is configured to engage in a receiving opening of a shaping rod, such that a demolding force is transferable to the shaping rod, in particular against the conveying direction.

44. System according to claim 43,
wherein the receiving opening comprises an internal thread, in particular a thread insert, and the coupling element is configured as a threaded pin.

45. System according to claim 43,
wherein the coupling element is configured as a bolt for forming a form fit with the receiving opening, to transfer the demolding force;
in particular wherein the receiving opening is configured with an undercut, and the bolt is configured for coupling in the receiving opening,
wherein the bolt is in particular configured as a ball lock bolt.

46. System according to claim 43,
wherein at least one of the shaping rods comprises the receiving opening at its surface, and
wherein the coupling element is coupleable into the receiving opening perpendicularly to the conveying unit.

47. System according to claim 43,
wherein the conveying unit comprises a further coupling element which is configured to engage in a receiving opening of a further shaping rod, such that a demolding force is transferable to a further shaping rod, in particular against the conveying direction;
in particular wherein the coupling element and the further coupling element are displaceable along the conveying direction independently from each other, to selectively apply a demolding force on the shaping rod or the further shaping rod along a deforming direction.

48. System according to claim 32, further comprising:
a cleaning unit for cleaning at least the front surfaces of the shaping rods,
wherein the cleaning unit comprises a cleaning opening, through which a rod to be cleaned is insertable along the conveying direction;
in particular wherein the cleaning unit comprises a spatula element which is configured such that, when displacing the shaping rod in the cleaning unit, the spatula element scratches along a surface and the front surface of the shaping rod.

49. System according to claim 32, further comprising:
a control unit for controlling the conveying unit,
wherein the control unit is configured to determine the position data of the single shaping rods for forming the casting mold based on model data of the casting model to be manufactured.

50. Method for flexibly forming a casting mold and for manufacturing a casting model, the method comprising:
conveying at least one shaping rod to a mounting platform,
wherein the conveying unit is configured to grip and to place the shaping rods on the mounting platform, such that a stack of the shaping rods is formable, and that a side of the stack is formable by the position of the shaping rods, to form a region of the casting mold.

51. System for manufacturing a molded body, the system comprising:
a mounting platform,
a plurality of shaping rods for forming the molded body, and
a conveying unit for conveying the shaping rods to the mounting platform,
wherein the conveying unit is configured to grip and to place the shaping rods on the mounting platform, such that a stack of the shaping rods is formable,
wherein the positions of the single shaping rods in the stack reproduce the shape of the molded body, and
wherein the shaping rods are gluable to each other, such that the stack forms the molded body.
